(19) United States
(12) Patent Application Publication
(10) Pub. No.: US 2013/0136506 A1
(43) Pub. Date: May 30, 2013

(54) DEVELOPING DEVICE

(71) Applicant: CANON KABUSHIKI KAISHA, Tokyo (JP)

(72) Inventor: Tomoyuki Sakamaki, Toride-shi (JP)

(73) Assignee: CANON KABUSHIKI KAISHA, Tokyo (JP)

(21) Appl. No.: 13/659,062

(22) Filed: Oct. 24, 2012

(30) Foreign Application Priority Data
Nov. 29, 2011 (JP) 2011-260885

(51) Int. Cl. G03G 15/09

(52) U.S. Cl. 399/269; 399/276

(57) ABSTRACT

A developing device includes first and second developer carrying members for developing an electrostatic latent image formed on an image bearing member. The first developer carrying member has a surface provided with grooves and feeds a developer carried thereon to a first developing region which is an opposing portion where the first developer carrying member opposes the image bearing member. The second developer carrying member carries the developer delivered from the first developer carrying member and feeds the developer to a second developing region which is an opposing portion where the second developer carrying member opposes the image bearing member. The second developer carrying member has a surface provided with grooves different in angle from those of the surface of the first developer carrying member.

### FIELD OF THE INVENTION AND RELATED ART

The present invention relates to a developing device for developing an electrostatic latent image, formed on an image bearing member by an electrophotographic process, an electrostatic recording process or the like, to form a visible image. Particularly, the present invention relates to the developing device for developing the electrostatic latent image by a plurality of developer carrying members having a grooved surface.

In an image forming apparatus such as a copying machine using the electrophotographic process, the developing device for visualizing the electrostatic latent image, formed on the image bearing member such as a photosensitive drum, by depositing a developer on the electrostatic latent image is provided. In such a developing device, a developing sleeve for carrying and feeding (conveying) the developer to a developing position where the developing sleeve opposes the photosensitive drum is provided. On a surface of some developing sleeve, unevenness (projections and recesses) is formed by sandblast in order to improve a feeding property. The developing sleeve having the unevenness by using the sandblast was accompanied with a problem that an amount of unevenness becomes small when the surface is abroad by use of the developing sleeve and thus a developer feeding performance is lowered. When the amount of unevenness is increased for enhancing the developer feeding performance, there is a need to effect blasting by hitting the developing sleeve surface by abrasive grain during machining, so that there arose a problem such that the developing sleeve is deformed. Therefore, as in Japanese Laid-Open Patent Application (JP-A) Hei 5-333691 and JP-A 2007-127907, a developing sleeve provided with a plurality grooves extended in parallel to a developing sleeve rotation shaft (axis) has been proposed. In machining of the grooves with a cutting tool or the like, different from the sandblast, it is possible to increase the amount of unevenness without deforming the developing sleeve.

In addition, the following developing device has been known.

Heretofore, in the case where a rotation movement speed of the photosensitive drum is relatively low, i.e., in the case of the copying machine operated at a relatively low speed, a sufficiently good development image was obtained even when a development time was short and therefore a single developing sleeve was enough for the development. However, in a stream of recent demands on speed-up of the copying machine, in the case where the rotation movement speed of the photosensitive drum became high, suitable image formation could not always be effected by using the single developing sleeve.

As a countermeasure thereagainst, there is a method of enhancing a developing efficiency by increasing a peripheral speed of the developing sleeve. However, when the peripheral speed of the developing sleeve is increased, centrifugal force acting on the developer which forms a magnetic brush becomes large and thus a degree of scattering of the developer becomes large to cause contamination inside the copying machine, so that there is a possibility of a lowering in apparatus (device) function.

Therefore, as another countermeasure, a plurality (two or more) of developing sleeves are provided by bringing their peripheral surfaces near to each other so as to be adjacent to each other and then the developer is fed (conveyed) so as to travel along the respective peripheral surfaces. A so-called multi-stage magnetic brush developing method in which the development time is prolonged by taking such countermeasure to enhance the developing performance has been proposed (Japanese Patent No. 02699968).

The developing sleeve provided with the grooves at its surface as in JP-A Hei 5-333691 and JP-A 2007-127907 is accompanied with the following problem. That is, in order to regulate a coating amount of the developing sleeve, a developer regulating member is provided opposed to the developing sleeve. When the surface of the developing sleeve passes through an opposing portion where the developing sleeve opposes the developer regulating member, an amount of the developer fed to the sleeve surface is changed between a groove region and a non-groove region. For this reason, an amount of a toner moved onto the photosensitive drum is changed between the groove region and the non-groove region, so that non-uniformity (banding) can occur on an output image with a groove pitch.

Further, also in the case where a developing sleeve provided with double-cut (crisscross) shaped bandings is used, the above banding generated depending on the presence or absence of each groove is caused to occur.

Especially, in the case of the developing device including the plurality of developing sleeves, when groove shapes of the respective developing sleeves are the same, surface portions generated due to the respective developing sleeves overlap with each other. For that reason, the banding is generated more conspicuously than the case where the image is outputted by using the developing device including the single developing sleeve.

### SUMMARY OF THE INVENTION

A principal object of the present invention is to provide a developing device, in which development is made by using a plurality developer carrying members, capable of reducing an image defect generated due to overlapping, on an image, of pitch non-uniformity portions generated by grooves of the respective developer carrying members.

According to an aspect of the present invention, there is provided a developing device comprising: first and second developer carrying members for developing an electrostatic latent image formed on an image bearing member, wherein the first developer carrying member has a surface provided with grooves and feeds a developer carried thereon to a first developing region which is an opposing portion where the first developer carrying member opposes the image bearing member; wherein the second developer carrying member carries the developer delivered from the first developer carrying member and feeds the developer to a second developing region which is an opposing portion where the second developer carrying member opposes the image bearing member, and wherein the second developer carrying member has a surface provided with grooves different in angle from those of the surface of the first developer carrying member.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of a structure of an image forming apparatus according to Embodiments 1 to 3 of the present invention.

FIG. 2 is a cross-sectional view of a developing device according to the present invention.

FIG. 3 is a sectional view of developing sleeves of the developing device according to the present invention.

FIG. 4 is a schematic illustration of an example of developing sleeves in Embodiment 1 of the present invention.

FIG. 5 is a schematic illustration of another example of the developing sleeves in Embodiment 1 of the present invention.

FIG. 6 is a schematic illustration of developing devices in Embodiment 2 of the present invention.

Parts (a) and (b) of FIG. 7 are schematic views for illustrating groove angle dependency of (developer) feeding forces in a rotational direction and a longitudinal direction.

FIG. 8 is a schematic illustration of developing sleeves in Embodiment 3 of the present invention.

FIG. 9 is a schematic illustration of a conventional developing device.

FIG. 10 is a schematic illustration of another conventional developing device.

### DESCRIPTION OF THE PREFERRED EMBODIMENTS

Hereinbelow, embodiments of the present invention will be described in detail with reference to the drawings. The present invention can also be carried out in other embodiments in which a part or all of constitutions of the following embodiments are replaced with alternative constitutions so long as in a constitution in which a plurality of developing sleeves are provided, angles of grooves formed on the respective developing sleeves are different from each other.

Therefore, an image forming apparatus in the present invention can be carried out irrespective of tandem type one-drum type, intermediary transfer type direct transfer type, and two-component developer/one-component developer. In the following embodiments, only a major part of the image forming apparatus relating to formation of a toner image will be described but the present invention can be carried out in various fields of apparatuses or machines such as printers various printing machines, copying machines, facsimile machines, and multi-function machines.

Incidentally, general matters of the image forming apparatuses described in JP-A Hei 5-333691, JP-A 2007-127907 and Japanese Patent No. 02699968 will be omitted from illustration and redundant description.

### Embodiment 1

### Image Forming Apparatus

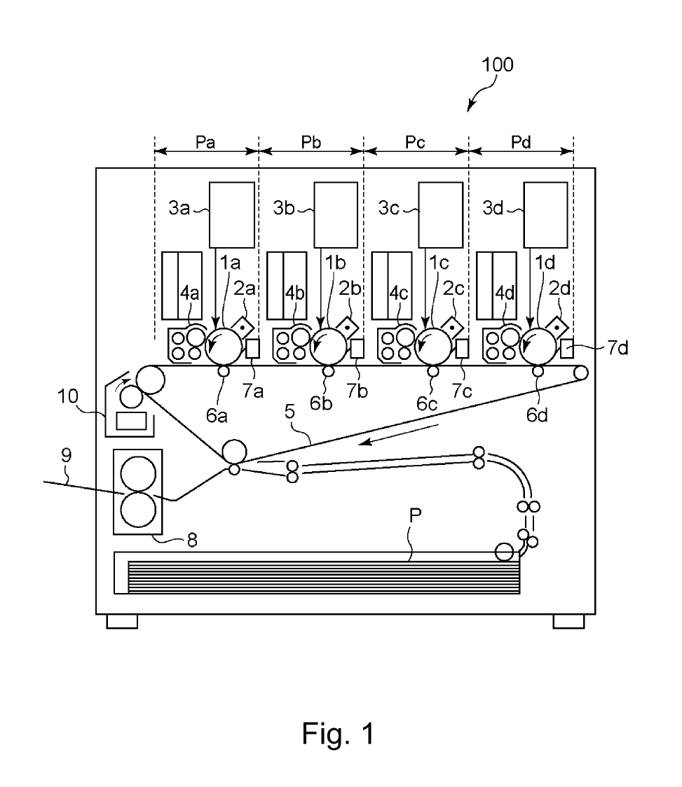

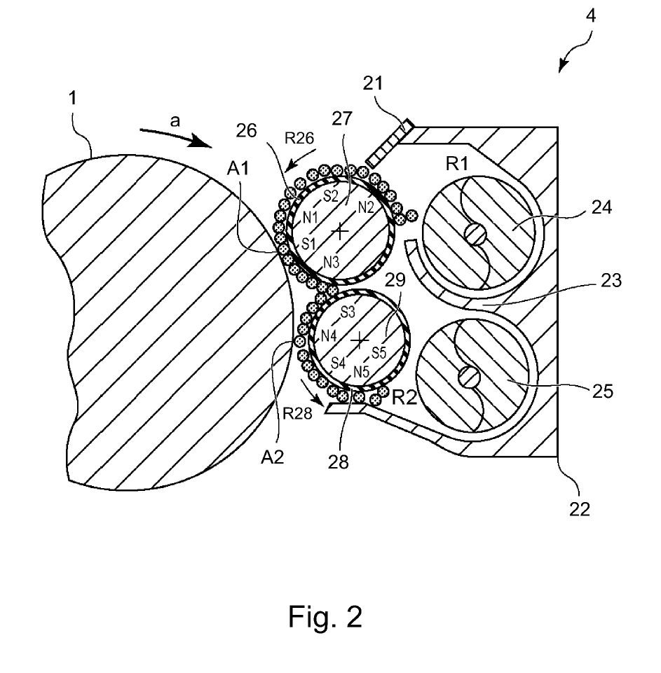

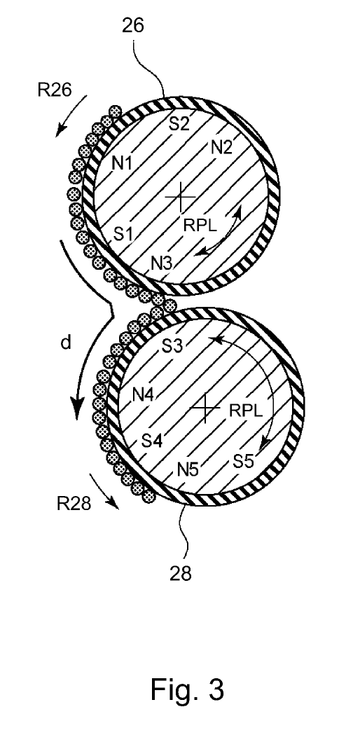

FIG. 1 is an illustration of a structure of an image forming apparatus. FIGS. 2 and 3 are illustrations of a structure of a developing device. As shown in FIG. 1, an image forming apparatus 100 is an intermediary transfer type full-color printer of the tandem type in which image forming portions Pa, Pb, Pc and Pd for different colors are provided along an intermediary transfer belt 5. Along the intermediary transfer belt 5 (intermediary transfer medium), together with a monochromatic image forming portion, a plurality of color (chromatic) image forming portions are disposed.

At the image forming portion Pa, a yellow toner image is formed on a photosensitive drum 1a as an image bearing member and then is primary-transferred onto the intermediary transfer belt 5. At the image forming portion Pb, a magenta toner image is formed on a photosensitive drum 1b and then is primary-transferred superposedly onto the yellow toner image on the intermediary transfer belt 5.

At the image forming portions Pc and Pd, a cyan toner image and a black toner image are formed on a photosensitive drum 1c and a photosensitive drum 1d, respectively, and are successively primary-transferred superposedly onto the intermediary transfer belt 5 in a similar manner.

The four color toner images primary-transferred on the intermediary transfer belt 5 are conveyed to a secondary transfer portion, at which the four color toner images are collectively secondary-transferred onto a recording material P. The recording material P on which the four color toner images are secondary-transferred is heated and pressed by a fixing device 8, so that the toner images are fixed on a surface of the recording material P. Thereafter, the recording material P is discharged onto a stacking tray 19.

The image forming portions Pa, Pb, Pc and Pd have the substantially same constitution except that the colors, of toners used for developing electrostatic latent images, consisting or yellow, magenta, cyan and black are different from each other. In the following description, the image forming portion Pa will be described and with respect to other image forming portions Pb, Pc and Pd, the suffix a of reference numerals (symbols) for representing constituent members (means) for the image forming portion Pa is to be read as b, c and d, respectively, for explanation of associated ones of the constituent members for the image forming portions Pb, Pc and Pd.

At the image forming portion Pa, around the photosensitive drum 1a, a corona charger 2a, an exposure device 3a, a developing device 4a, a primary transfer roller 6a and a cleaning device 7a are provided. The photosensitive drum 1a is constituted by forming a negatively chargeable photosensitive layer on an outer peripheral surface of an aluminum cylinder and is rotated at a process speed of 273 mm/sec in an arrow direction. The surface of the photosensitive drum 1a is irradiated with charged particles, generated by corona discharge, by the corona charge 2a, so that surface of the photosensitive drum 1a is electrically charged uniformly to a negative-polarity potential. The exposure device 3a writes (forms) an electrostatic (latent) image for an image on the charged surface of the photosensitive drum 1a by scanning of the charged surface through a rotation mirror with a laser beam obtained by ON-OFF modulation depending on scanning line image data expanded from a separated color image for yellow.

The developing device 4a stirs the two-component developer principally containing a magnetic carrier and a non-magnetic toner to charge the magnetic carrier and the non-magnetic toner to the positive polarity and the negative polarity, respectively. The charged two-component developer is carried on a developing sleeve rotating around fixed magnetic poles and rubs the photosensitive drum 1a. An oscillating voltage in the form of a negative-polarity DC voltage biased with an AC voltage is applied to the developing sleeve, so that the toner charged to the negative polarity is transferred onto the electrostatic image on the photosensitive drum 1a having the positive polarity relative to the polarity of the developing sleeve and thus the electrostatic image is reversely developed.

The primary transfer roller 6a urges the intermediary transfer belt 5 to form a primary transfer portion between the photosensitive drum 1a and the intermediary transfer belt 5. By applying a positive-polarity DC voltage to the primary transfer roller 6a, the negative charged toner image carried on the photosensitive drum 1a is primary-transferred onto the intermediary transfer belt 5 passing through the primary transfer portion. The cleaning device 7a rubs the photosensitive drum 1a with a cleaning blade to collect a transfer residual toner which is not subjected to the primary transfer onto the intermediary transfer belt 5 but remains on the photosensitive drum 1a. A transfer belt cleaning device 10 collects a transfer residual toner which is not subjected to the secondary transfer onto the recording material P but remains on the intermediary transfer belt 5.

### <Developing Device>

With reference to FIGS. 2 and 3, detailed description of the developing device 4 will be made.

The present invention aims at solving the above-described problem of the developing device including the plurality of developing sleeves and therefore constituents of the developing device will be specifically described below in turn.

The developing device 4 includes a developing container 22, and an inner portion of the developing container 22 is partitioned into a developing chamber R1 and a stirring chamber R2 by a partition wall 23. In the developing chamber R1 and the stirring chamber R2, the developer containing the toner and the magnetic carrier in mixture is accommodated. As the magnetic carrier used in the present invention, a ferrite carrier, a resinous magnetic carrier containing a binder resin, a magnetic metal oxide and a non-magnetic metal oxide, or the like carrier may be used.

In the developing chamber R1, a feeding screw 24 is accommodated and feeds the developer along a longitudinal direction of developing sleeves 26 and 28 by its rotation drive. A developer feeding direction of a screw 25 accommodated in the stirring chamber R2 is opposite to that of the screw 24.

The partition wall 23 is provided with an opening in each of a front side and a rear side. The developer fed by the screw 24 is delivered from one of the openings to the screw 25, and the developer fed by the screw 25 is delivered from another opening to the screw 24.

The developing container 22 is provided with an opening at a position, close to the photosensitive drum 1, where the two developing sleeves consisting of an upstream developing sleeve 26 and a downstream developing sleeve 28 are provided. Each of the two developing sleeves is 1 mm in thickness, 25 mm in outer diameter and 350 mm in length with respect to a thrust direction.

In the upstream developing sleeve 26, a (roller-shaped) first magnetic roller 27 is fixedly provided. The upstream developing sleeve 26 is rotated in a direction of an arrow R26 (opposite to the rotation direction of the photosensitive member), thus carrying and feeding the developer. Above the upstream developing sleeve 26, a regulating blade 21 is provided and in the neighborhood of the regulating blade 21, a magnetic pole N2 of the magnetic roller 27 is provided. The developer stagnated by being constrained by a magnetic force of the magnetic pole N2 is, after being regulated by the regulating blade 21 to provide a proper developer layer thickness, carried and fed to a first developing region A1 which is an opposing portion where the upstream developing sleeve 26 opposes the photosensitive drum 1. The first magnetic roller 27 has a developing magnetic pole S1 opposing the first developing region A1. A magnetic brush of the developer is formed by a developing magnetic field formed in the first developing region A1 by the developing magnetic pole S1, and this magnetic brush contacts the photosensitive drum 1, rotating in an arrow a direction, in the first developing region A1 and develops the electrostatic latent image at the first developing region A1. At that time, also the toner deposited on the magnetic brush and the toner deposited on the developing sleeve surface are transferred onto an image region of the electrostatic latent image to develop the electrostatic latent image. In this embodiment, the first magnetic roller 27 has magnetic poles N1, N3 and S2 in addition to the above-described magnetic poles S1 and N2. Of these magnetic poles, the N2 pole and the N3 pole are the same polarity and are adjacent to each other, so that a repelling magnetic field is formed and therefore a barrier against the developer is formed.

The downstream developing sleeve 28 as a second developer carrying means is provided, rotatably in an arrow R28 direction (identical to the rotational direction R26 of the upstream developing sleeve 26), below the upstream developing sleeve 26 and in a region substantially opposing both of the upstream developing sleeve 26 and the photosensitive drum 1. This downstream developing sleeve 28 is constituted by the non-magnetic material similarly as in the case of the upstream developing sleeve 26. Inside the downstream developing sleeve 28, a (roller-shaped) second magnetic roller 29 as a magnetic field generating means is provided in a non-rotatable state. This second magnetic roller 29 includes 5 magnetic poles consisting of magnetic poles S3, N4, N5 and S5. The magnetic brush on the N4 pole of these magnetic poles contacts the photosensitive drum 1 in a developing region A2 and effects second-time development on the photosensitive drum 1 after passing through the first developing region A1. The S3 pole and the S5 pole have the same polarity and between the S3 pole and the S5 pole, repelling magnetic field is formed, so that a barrier against the developer is formed. Of these poles, the S3 pole opposes the N3 pole of the first magnetic roller 7 incorporated in the upstream developing sleeve 26 in the neighborhood of a position where both of the sleeves are closest to each other. In the following, a flow of the developer will be described with reference to an enlarged view (FIG. 3) in the neighborhood of the first developing sleeve 26 and the second developing sleeve 28. Between the N3 pole and N2 pole of the first developing sleeve 26, the repelling magnetic field is formed, and also between the S3 pole and S5 pole of the second developing sleeve 28, the repelling magnetic field is formed. For this reason, the developer conveyed on the first developing sleeve 26 and passing through the developing region reaches the N3 pole and cannot pass through the closest position of the developing sleeves by the repelling magnetic field, so that as indicated by an arrowed, the developer is moved toward the downstream developing sleeve 28 side along lines of magnetic force extending from the N3 pole toward the S3 pole. Then, on the downstream developing sleeve 28, the developer is conveyed to the feeding screw 25 in the stirring chamber R2. As in this embodiment, below the upstream developing sleeve 26, the downstream developing sleeve 28 is provided, so that the developer is conveyed on the upstream developing sleeve 26 in the order of N2, S2, N1, S1 and N3. Thereafter, the developer on the upstream developing sleeve 26 is blocked by the repelling magnetic fields of the developing sleeves 26 and 28, thus being moved to the downstream developing sleeve 28. Then, the developer is conveyed on the downstream developing sleeve 28 in the order of S3, N4, S4, N5 and S5 and is blocked at the S5 pole by the repelling magnetic field, thus being removed and dropped into the stirring chamber R2.

Incidentally, the N3 pole and the S3 pole which are delivery poles are not required to completely oppose to each other. The delivery of the developer can be smoothly performed when those poles substantially oppose to each other within a range of a deviation state of 45 degrees from the completely opposing state.

### <Developing Sleeve>

Condition of the developing sleeves 26 and 28 used in this embodiment will be described in detail.

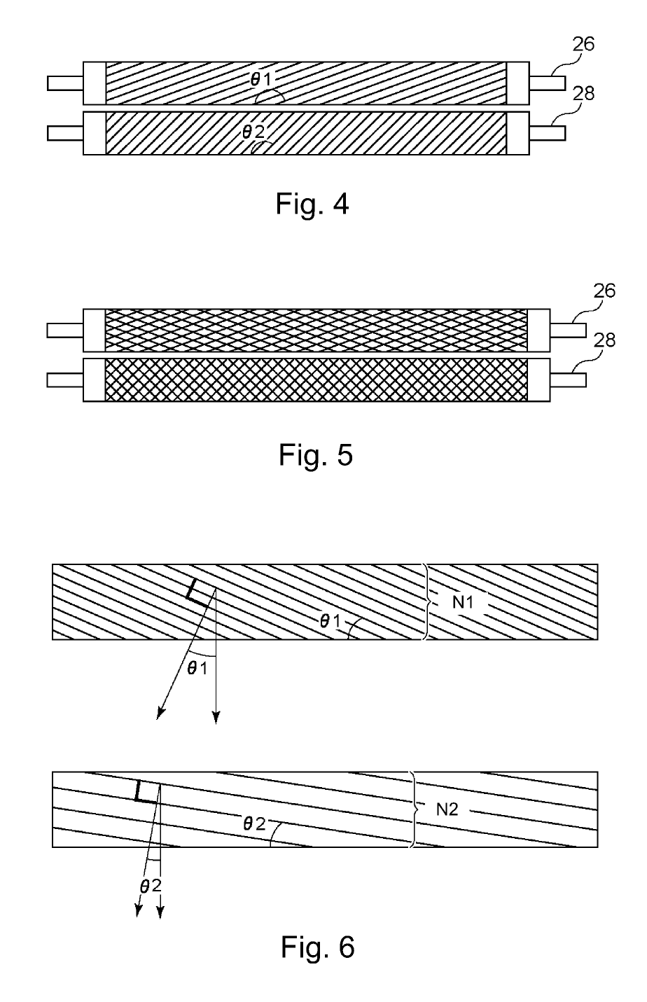

FIG. 4 is an enlarged view of surfaces of the developing sleeves 26 and 28. Each of the surfaces of the developing sleeves 26 and 28 in this embodiment is provided with oblique line-like grooves. The oblique line-like grooves are formed by providing a plurality of grooves inclined with respect to an axial direction (thrust direction) of the associated developing sleeve. According to such a sleeve provided with the oblique line-like grooves, when the developer passes through the regulating blade 21 for regulating an amount of the developer at a certain amount, feeding grooves are obliquely provided and therefore the developer is prevented from being under stress. For that reason, a lifetime of the developer can be prolonged and at the same time, impact during passing of the developer through the regulating blade 21 can be relieved due to the oblique developer feeding grooves, so that shock jitter is also remedied.

In this embodiment, the grooves provided on each developing sleeve are formed in a depth of about 50-200 μm from a region where there is no groove. In a general blast method, minute recesses of the developing sleeve surface is about 10 μm in depth and on the other hand, the grooves as used in the present invention have a large depth and therefore a developer feeding performance on the developing sleeve surface is very high compared with that in the general blast method. Further, the depth of the grooves may preferably be not less than a particle size of the carrier used. Further, a groove interval is about 0.5-1 mm and the grooves are formed with a width of 0.05-0.2 mm. These setting values may suitably be optimized depending on the developing device used.

The developing device used in this embodiment includes the plurality of the developing sleeves (two developing sleeves 26 and 28 in this embodiment). In this embodiment, as shown in FIG. 4, when the oblique line-like grooves are formed on each developing sleeve, a feature is such that an angle of the grooves of each of the developing sleeves 26 and 28 is different.

The grooves were formed at θa and θb, as a groove angle θ, on the developing sleeves 26 and 28, respectively. In this embodiment, as an example of each groove angle, the groove angle was adjusted so as to be θa=about 150 degrees and θb=about 110 degrees and the developing sleeves 26 and 28 were used for development with toners of different colors.

As described above, in the case where the grooves are formed along the axial direction (thrust direction) of the developing sleeves 26 and 28, banding generated slightly by each of the developing sleeves 26 and 28 can be outputted in an emphasized state. At this time, the entire thrust region is emphasized and therefore there arises a problem such that the banding is liable to be very conspicuous. Even when a groove pitch of each of the developing sleeves 26 and 28 is changed, there is no change in that the entire thrust region can be emphasized.

As in this embodiment, in the case where the groove angle is changed between the upstream developing sleeve 26 and the downstream developing sleeve 28, the banding slightly appearing in the angle of the grooved sleeve by the upstream developing sleeve 26 can be prevented from being emphasized by the change in groove angle of the downstream developing sleeve 28 from the upstream developing sleeve 26. In addition, an effect of canceling banding portions, appearing at the respective angles, to each other can be obtained, with the result that a degree of the banding can be reduced on a final output image.

As for a matter that the grooved sleeve with which groove angle is employed as each of the developing sleeves 26 and 28 of the developing device 4 in this embodiment, even when any combination is used, the banding reducing effect can be obtained so long as the groove angles of the developing sleeves 26 and 28 are different from each other. However, in order to obtain a higher effect, the groove angles may preferable be different by 15 degrees or more. On the other hand, when the groove angle difference is 10 degrees or less, the groove angles are not so different and therefore there is a possibility that the banding portions are emphasized by each other in a broad thrust range.

Further, according to this embodiment, the developing sleeves 26 and 28 each provided with the oblique line-like grooves are employed as described above but a similar effect can be obtained also when developing sleeves provided with crisscross (double-cut)-like grooves as shown in FIG. 5 are used. The crisscross-like grooves are formed by crossing a plurality of grooves inclined with respect to the thrust direction of the developing sleeve with a plurality of grooves inclined with respect to an opposite direction. The inclination angle of the former plurality of grooves and that of the latter plurality of grooves are not necessarily be identical to each other.

Here, a manufacturing method of the grooved sleeves employed in this embodiment will be described. Each of the grooved sleeves in this embodiment is prepared by cutting (machining). By using dice provided with cutters in a circular shape corresponding to the number of grooves, the developing sleeve surface can be but to prepare the grooved sleeve. Here, a manner of providing the oblique line-like grooves, employed in this embodiment, with an angle will be described. In a cutting machine, both end portions of a rotation shaft of the developing roller are supported and the developing sleeve is pushed toward the dice in the longitudinal direction while rotating the developing sleeve, so that the grooves with a predetermined angle can be formed by the cutting. The grooved sleeves, changed in oblique line-like groove angle, employed in this embodiment can be prepared, as an angle-adjusted product, by changing a developing sleeve rotational speed in the above-described cutting method and then by pushing and cutting the developing sleeve to be changed in groove angle.

Incidentally, in the case of the developing device including three or more developing sleeves, the grooves are not necessarily required to be formed on all of the developing sleeves. In this case, when there are at least two developing sleeves having surfaces where the grooves are formed, the present invention can be applied, and when the grooved developing sleeves are different in groove angle, the effect of the present invention is achieved.

### Embodiment 2

In the image forming apparatus described in Embodiment 1, in the case where the developing sleeves are changed in groove inclination, the developing sleeves are different in developer feeding property.

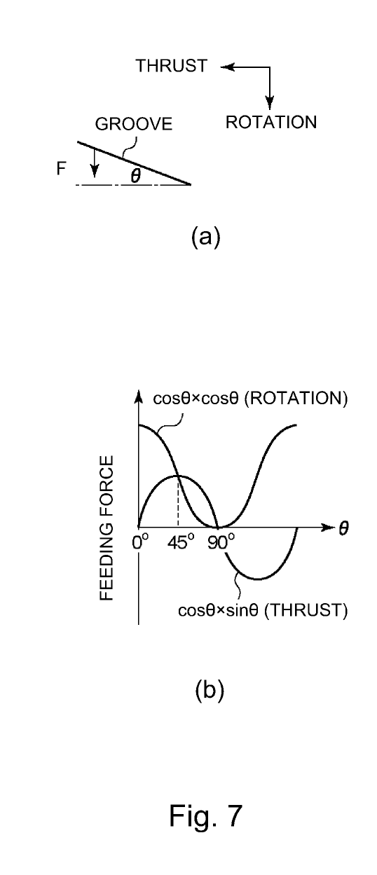

With respect to the feeding property of the groove-shaped sleeve, a (developer) feeding force acts on the grooves with respect to the thrust direction. In the case of the oblique line-like grooves, as shown in FIG. 6, when an angle formed between each groove and the thrust direction of the developing sleeve is θ (θa or θb), a feeding force corresponding to cos θ with respect to the vertical direction of the oblique line-like grooves acts in the sleeve rotational direction.

For this reason, the feeding force of the developing sleeve is changed when the inclination (angle) of the oblique line-like grooves is changed, and therefore an amount of the developer conveyed on the developing sleeve is changed. When the amount of the developer on the developing sleeve is changed, a developing characteristic is changed. The developing characteristic means a toner movement amount when a predetermined electric field is applied between the developing sleeve and the photosensitive drum. For that reason, in this embodiment, a developing device having an unchanged developing characteristic is provided even when the plurality of developing sleeves are different in oblique line-like groove angle.

In order to leave the feeding force of the developing sleeve unchanged even when the oblique line-like groove angle is changed, the number of the oblique line-like grooves may preferably be changed depending on the groove angle. The feeding force of the developing sleeve is proportional to the number of the grooves and therefore when the groove angle becomes large, a feeding force cos θ component of the developing sleeve with respect to the rotational direction becomes small. Therefore, correspondingly, the number of the grooves may preferably be increased. As a result, even when the groove angle is changed, it becomes possible to provide the oblique line-like developing sleeve which does not change its (developer) feeding force to the possible extent.

Parts (a) and (b) of FIG. 6 are model views for illustrating the case where the groove angle is changed and the number of grooves. In the case where the developing sleeve rotational speed is V and the number of grooves per unit length of the developing sleeve is N, the feeding force with the rotation of the developing sleeve is proportional to each of V and N. In the case where the grooves have the oblique line shape as in the present invention, when an angle of each groove formed with respect to the axial direction is θ ((a) of FIG. 7), the feeding force of the oblique line-like grooves in the vertical direction is proportional to V×N×cos θ. Further, as described above, the feeding force of the oblique line-like grooves corresponding to cos θ with respect to the vertical direction acts in the sleeve rotational direction. For this reason, with respect to a force (component) of the feeding force in the rotational direction with the rotation of the oblique line-like grooves, the feeding force in the rotational direction can be estimated as being proportional to V×N×cos θ×cos θ=V×N×{(½)+(½)cos 2θ}. For reference, a graph of cos θ×cos θ was shown in (b) of FIG. 7. The feeding force becomes minimum when the groove angle is 90 degrees, i.e., when the grooves are perpendicular to the axial direction.

In the developing device in which the plurality of the developing sleeves are different in groove angle, in order to leave the feeding force unchanged to the possible extent even when the groove angle, V×N of the developing sleeve having a smaller value of cos θ×cos θ may preferably be made large. Particularly, in the case where the rotational speeds of the two developing sleeves are the same, the number N of the grooves of the developing sleeve having the smaller value of cos θ×cos θ may preferably be made large. In this embodiment, the rotational speeds of the two developing sleeves are the same and therefore the groove number N of the upstream developing sleeve 26 having the smaller value of cos θ×cos θ than that of the downstream developing sleeve 28 is made larger than the groove number N of the upstream developing sleeve 26.

At this time, when the following relational expression (1) is satisfied, the feeding force of the downstream developing sleeve 28 can be made identical to that of the upstream developing sleeve 26.

V1×N1×cos θ1×cos θ1=V2×N2×cos θ2×cos θ2 (1)

By keeping this relational expression (1), even when the groove angle of the developing sleeve in each developing device is changed, each developing device can be used without changing its developing characteristic. As a result, it becomes possible to provide a high-quality image forming apparatus which can reduce the degree of the banding and which is excellent gradation characteristic.

It is ideal that the feeding force of the downstream developing sleeve 28 can be made identical to that of the upstream developing sleeve 26 as described above, but there is also the case where it is difficult to make the feeding force of the downstream developing sleeve 28 completely identical to that of the upstream developing sleeve 26. In that case, when the feeding force of the downstream developing sleeve 28 is smaller than that of the upstream developing sleeve 26, the downstream developing sleeve 28 cannot completely convey the developer conveyed by the upstream developing sleeve 26, so that the developer is liable to stagnate between the developing sleeves 26 and 28. For that reason, it is preferable that the feeding force of the downstream developing sleeve 28 is made larger than that of the upstream developing sleeve 26. This means that a relational expression (2) below is satisfied. In the relational expression (2), N1 cos θ1 represents the feeding force of the upstream developing sleeve 26, and N2 cos θ2 represents the feeding force of the downstream developing sleeve 28.

V1×N1 cos θ1×cos θ1<V2×N2 cos θ2×cos θ2 (2)

Incidentally, also in this embodiment described above, the developing sleeve on which the oblique line-like grooves are formed is employed as an example but a similar effect can be obtained even when a developing sleeve on which crisscross-like grooves are formed is used.

### Embodiment 3

The oblique line-like grooves has a feeding force in the axial (thrust) direction in addition to the sleeve rotational direction. For that reason, there can arise a possibility that the developer is liable to be localized in one side of the developing sleeve with respect to the thrust direction during the conveyance thereof on the developing sleeve. In Embodiment 1, both of the oblique line-like groove angles are 90 degrees or more but in that case, the thrust feeding directions of the developer on the respective developing sleeves becomes the same, so that the developer is more liable to be localized during the conveyance thereof on the two developing sleeves. When the developer is localized, there arises a possibility that the developer is leaked out to the outside of a feeding region at the sleeve end portion.

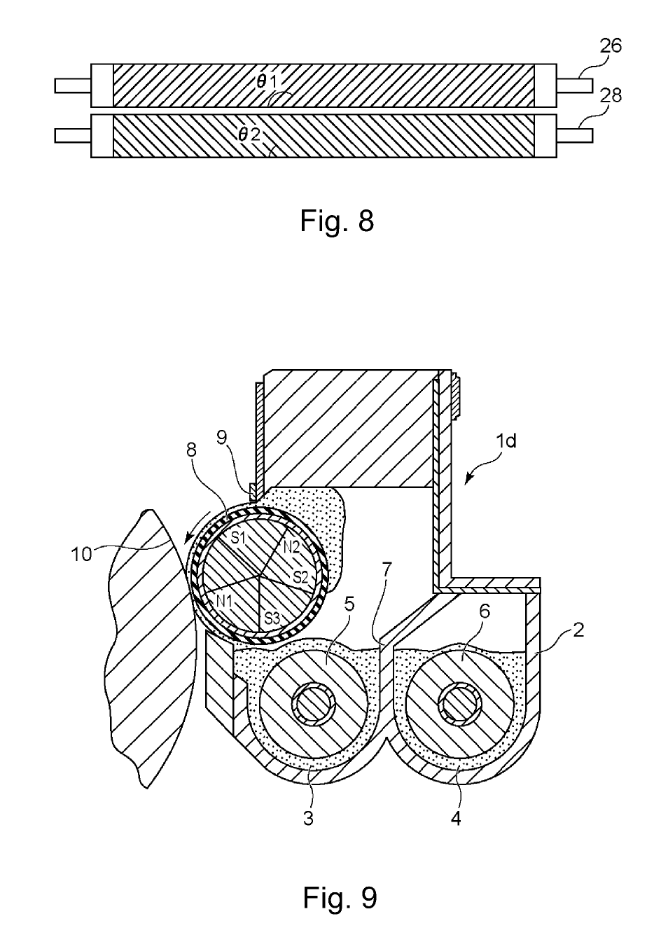

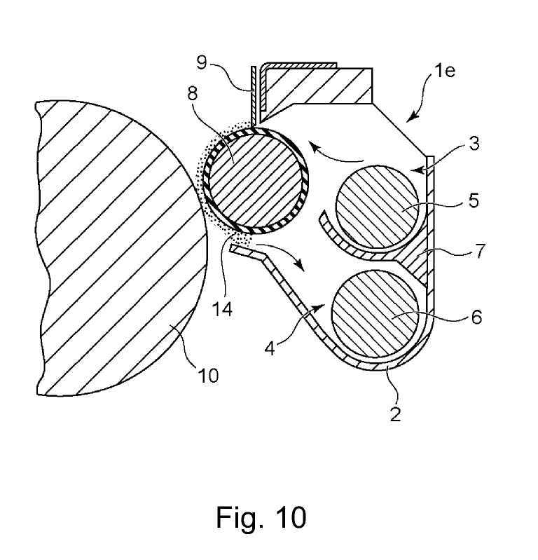

Therefore, in this embodiment, as shown in FIG. 8, oblique line-like groove angles of an upstream developing sleeve 26 provided in an upstream side and a downstream developing sleeve 28 provided in a downstream side with respect to the developer feeding direction are set so that (developer) feeding forces of the developing sleeves 26 and 28 in the thrust direction are executed in directions opposite to each other. Thus, a degree of the localization of the developer can be reduced.

With respect to the feeding force obtained by the grooves with the rotation of the developing sleeve, in the case where an angle of each groove with respect to the axial direction of the developing sleeve is θ (θ1 and θ2 in (a) of FIG. 7), the feeding force in the thrust direction can be estimated as being proportional to sin θ cos θ=F×(½)sin 2θ. In (b) of FIG. 7, a graph of sin θ cos θ is shown but in order to exert the feeding forces in the thrust direction of the developing sleeves in the directions opposite to each other, it is understood that the groove angles θ and θ may only be required to be selected from ranges of 0-90 degrees and 90-180 degrees, respectively.

Incidentally, absolute values of the feeding forces in the thrust direction of the developing sleeves are made the same, so that a reduction in degree of localization can be effectively made.

|V1×N1 cos θ1×sin θ1|=V2×N2 cos θ2×sin θ2| (3)

It is ideal that the feeding force of the downstream developing sleeve 28 can be made identical to that of the upstream developing sleeve 26 as described above, but there is also the case where it is difficult to make (an absolute value of) the feeding force of the downstream developing sleeve 28 in the thrust direction completely identical to that of the upstream developing sleeve 26.

In that case, by setting parameters of at least the downstream developing sleeve 28 so as to satisfy a relational expression (4) below, it is possible to prevent the developer from being worsen with respect to the localization caused by excessive returning of the developer by the downstream developing sleeve 28.

|V1×N1 cos θ1×sin θ1|≦|V2×N2 cos θ2×sin θ2| (4)

That is, in the case where the directions of the feeding forces in the thrust direction of the upstream developing sleeve 26 and the downstream developing sleeve 28 are opposite to each other and the (absolute values of the) feeding forces in the thrust direction of the upstream developing sleeve 26 and the downstream developing sleeve 28 are different from each other, the following constitution may preferably be employed. That is, the sleeve having the larger feeding force in the thrust direction may preferably be disposed as the downstream developing sleeve. In other words, the feeding force in the thrust direction of the downstream developing sleeve may preferably be larger than that of the upstream developing sleeve. The reason therefor is as follows.

In the case where the upstream developing sleeve is larger in feeding force in the thrust direction than the downstream developing sleeve, first, the developer on the upstream developing sleeve largely receives the feeding force in the thrust direction toward the outside of the developer carrying region and then is moved and returned toward the opposite side with respect to the thrust direction by the downstream developing sleeve. For this reason, a fluctuation (maximum amplitude) of the developer with respect to the thrust direction is represented by |V2×N2 cos θ2×sin θ2|. On the other hand, in the opposite case, the developer on the upstream developing sleeve receives a relatively small force to be moved in the thrust direction toward the outside of the developer carrying region in advance. For this reason, thereafter, even when the developer receives a relatively large force to be returned toward an opposite side of the thrust direction by the downstream developing sleeve, the fluctuation (maximum amplitude) of the developer with respect to the thrust direction can be made smaller than |V2×N2 cos θ2×sin θ2|. However, the position where the developer is conveyed (fed) by the upstream and downstream developing sleeves and is moved in the thrust direction to finally reach is the same.

Incidentally, the relational expressions (1) and (3) can be satisfied at the same time when a relationship of |cos θ1/sin θ1|=|cos θ2/sin θ2|. In the present invention, θ1 is not equal to θ2 and therefore when θ2=180 (degrees)−θ is satisfied, the relation expressions (1) and (3) can be satisfied concurrently, thus providing a preferred constitution.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 260885/2011 filed Nov. 29, 2011, which is hereby incorporated by reference.

What is claimed is:

1. A developing device comprising:
first and second developer carrying members for developing an electrostatic latent image formed on an image bearing member,
wherein said first developer carrying member has a surface provided with grooves and feeds a developer carried thereon to a first developing region which is an opposing portion where said first developer carrying member opposes the image bearing member;
wherein said second developer carrying member carries the developer delivered from said first developer carrying member and feeds the developer to a second developing region which is an opposing portion where said second developer carrying member opposes the image bearing member, and
wherein said second developer carrying member has a surface provided with grooves different in angle from those of the surface of said first developer carrying member.

2. A developing device according to claim 1, wherein when a number of the grooves per unit length with respect to a circumferential direction of an associated developer carrying member is N, a rotational speed of the associated developer carrying member is V, and an angle formed between each groove and an axial direction of the associated developer carrying member is θ, a value of V×N×cos θ×cos θ of said second developer carrying member is equal to or larger than that of said first developer carrying member.

3. A developing device according to claim 1, wherein a direction of a developer feeding force by the grooves with respect to an axial direction of an associated developer carrying member is different between said first developer carrying member and said second developer carrying member.

4. A developing device according to claim 3, wherein the developer feeding force of said second developer carrying member is larger than that of said first developer carrying member.
